(19) United States
(12) Patent Application Publication
(10) Pub. No.: US 2009/0177469 A1
(43) Pub. Date: Jul. 9, 2009

(54) SYSTEM FOR RECORDING AND ANALYSING MEETINGS

(75) Inventor: Gregory Findlay, Queensland (AU)

Correspondence Address: YOUNG & THOMPSON, 209 Madison Street, Suite 500, ALEXANDRIA, VA, 22314, US

(73) Assignee: VOICE PERFECT SYSTEMS PTY LTD, Queensland (AU)

(21) Appl. No.: 11/816,850

(22) PCT Filed: Feb. 22, 2006
(86) PCT No.: PCT/AU06/00222

§ 371 Date: Nov. 2, 2007

(30) Foreign Application Priority Data
Feb. 22, 2005 (AU) 2005900817

(51) Int. Cl. G10L 15/26

(52) U.S. Cl. 704/235; 704/E15.001

(57) ABSTRACT

A system for producing a transcript of a meeting having n attendees, the attendees being identified as ID1 to IDn and channel 1 to channel n. A speech discriminator includes a channel monitor which generates a speech output from one or more of channels 1 to n at any one times a speech file selector at 14 and a speech file database at 15. Discrimination is on the basis of pre-allocated channels which correspond to pre-allocated microphones which are matched by ID and to the speech files in the speech file database. The effect of 13, 14 and 15 is to match a channel input to a particular speech file in the database 15 so that this information may then be passed to the audio to text convertor such that the speech file information and the input audio may be converted to text, displayed and written to a text file.

### TECHNICAL FIELD OF THE INVENTION

THIS INVENTION relates to the use of speech recognition technology for recording meetings and in particular but not limited to a management tool for post meeting analysis of a meeting transcript.

### BACKGROUND OF THE INVENTION

Speech recognition technology has improved to such a level that its use is becoming more and more common. An example of current speech recognition software is Dragon™ Naturally Speaking which uses a speech profile comprising a number of files (speech file) to recognise a user's utterances to generate text or commands. A microphone is placed in a reproducible position so that the profile may be properly matched to the user each time the program is used. One problem with the present technology is that it is single user.

U.S. Pat. No. 6,477,491, the disclosure of which is incorporated herein by reference describes use of the Dragon software in a meeting environment to record buy sell events and although produces a transcript of very limited vocabulary lacks any mechanism for time sequencing or of post meeting analysis.

Other publications include the following, in a publication the first delivered at ICASSP on 12-15 May 1998 by Yu et al entitled “Experiments in Automatic Meeting Transcription Using JRTK” and the second a paper delivered to DARPA February 1998 by Waibel et al also deals with the same subject. However, according to the authors the proposals set out in these papers are preliminary and not commercially workable.

Accordingly it is an object of the present invention to provide a system for producing a transcript of a meeting that alleviates at least to some degree the problems of the prior art.

It is a further and preferred object to provide a transcript with temporal resolution of utterances that may enable the transcript to be subjected to automated analysis and processing to provide graphical or other useful output tools from the meeting.

### OUTLINE OF THE INVENTION

In one aspect therefore the present invention resides in a system for producing a transcript of a meeting comprising n attendees, the system comprising at least one audio input device to receive individual utterances from attendees, a voice discriminator to discriminate between individual attendees' utterances, an audio to text convertor to convert the utterances to text and a compiler to compile the converted text into a meeting transcript. Preferably, each attendee has a separate microphone as audio input device. It should be appreciated that the audio input device may comprises an input of a electronic version of speech. Thus in the present invention the audio may be provided as a recording in digital or analogue form that may then be analysed using the present invention. Thus the audio and its analysis may or may not be in real time.

In a preferred form the invention involves analysis of the text as a management tool by including automated post text analysis using attendee identifiers (ID) and relating that to specified characteristic of the text. This may be used to identify useful management parameters including frequency of contribution, concepts contributed, assertiveness and so on. This may be married to video and audio so that sections extracted text identified as assertive or abusive may be further analysed to assess body language and other factors that might lead to improved meeting style or identify strength and weaknesses of individuals.

Accordingly in a preferred form there is provided a management tool comprising a speech to text system to provide a transcript of a meeting involving attendees, each attendee having unique identifier, the tool including post meeting text analysis so that each attendees contribution may be extracted for further analysis or is analysed against certain predetermined criteria. An example might be used in a corporate meeting or it may even be used in team events where the “attendee” is a team rather than an individual. An example of a team event might be a debate where the post debate analysis is automatic and results in a score.

The voice discriminator preferably comprises pre-allocation of microphones to attendees so that the microphones and associated input channels correspond to pre-stored speech profiles for the respective attendees.

Typically individual attendee's utterances are processed separately using respective channels and a timer sequence is used in conjunction with the compiler to create the transcript from the individual text. Thus individual utterances are time stamped. This has the advantage of being able to track development of an idea over time, temporal element analysis, thought progression, immediacy and context in meeting minutes with corresponding transcript and the change in time over a single meeting or over separate meetings.

The audio to text convertor may be any proprietary speech recognition such as the aforementioned Dragon™ Naturally Speaking.

The compiler interleaver may utilise flags of individual input to the meeting by time or by sequence. In the case of sequence a number is allocated to each utterance and the number incremented and the compilation is singly generated by reproducing the text of each channel in numerical sequence. In a more complex output that involves video and/or audio output in sequence with the text a timer delay created by text conversion process may be imposed on the video and audio.

In an especially preferred embodiment utterances are flagged by attendee ID so that modified propriety concept mapping software may be used to generate concept maps, this modification enables the concept maps to identify the contributions of individual attendees. This has the advantage that a concept may be readily identified as to veracity and meaning with the individual concerned, responsibility allocated, actions plans issued and credit for ideas duly recorded automatically. Therefore in one preferred aspect there is provided a system for producing concept maps of a meeting comprising n attendees, the system comprising a voice discriminator to discriminate between individual attendees' utterances, an audio to text convertor to convert the utterances to text and a concept mapper to extract key concepts from the text and present those in a graphical form. Preferably the system is able to identify the concepts of attendees using attendee identifiers and time/sequence tags to track development of ideas/concepts over time.

Preferably, the vocabulary is not general use for voice recognition but is tailored to the technical vocabulary of the individual making the utterances.

In a further aspect, there is provided a process for temporal tracing of cognition development including development of a relationship between ideas/concepts over time, time tracking the way in which links between concepts and ideas become evident to members of a group, allowing the strength of an idea/concept pair to be tracked over time, both on an individual basis and through the group as a whole.

### BRIEF DESCRIPTION OF THE DRAWINGS

In order that the present invention may be more readily understood and be put into practical effect, reference will now be made to the accompanying drawings which illustrate a preferred embodiment and wherein:

FIG. 1 there is an overview of the high level design of the present system in its preferred form as applied in a server based environ.

FIG. 2 is a block diagram illustrating a typical system according to the teachings of the present invention;

FIG. 3 is a flow chart illustrating the process by which text is displayed in sequence on a main screen for two attendees;

FIG. 4 is a flow chart illustrating the process by which a speech file database is generated and microphones allocated prior to the recording and conversion as set out in FIG. 3; and

FIG. 5 is a flow chart illustrating the generation of concept maps where individual input is generated based on mic input and hence attendee input for the provision of a typical management tool.

### METHOD OF PERFORMANCE

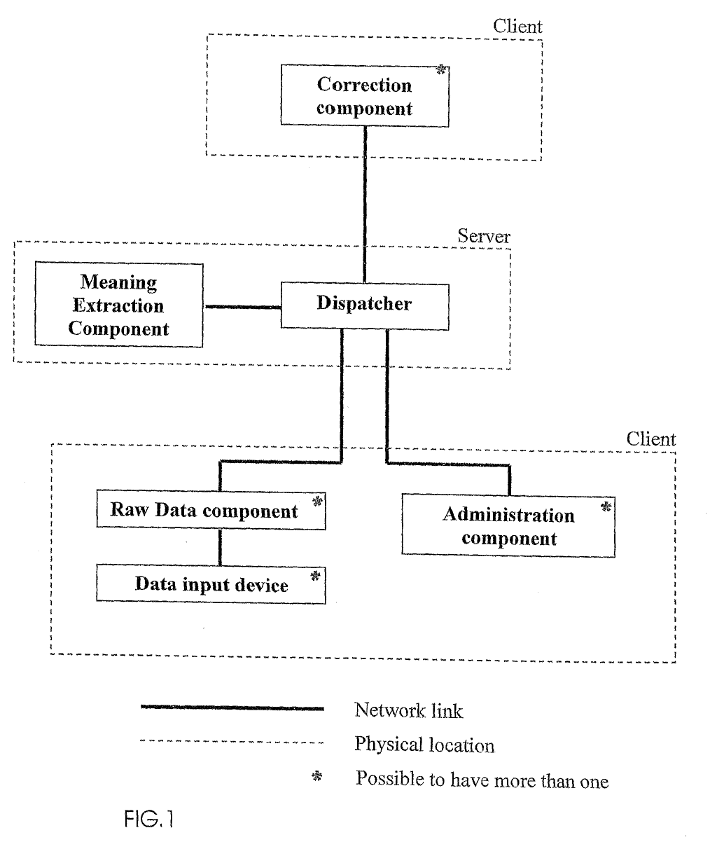

Referring to FIG. 1 there is illustrated an overview of the high level design of the present system in its preferred form.

### Data Capture Process

1. The Dispatcher Component connects to the Meaning Extraction Component, Raw Data Component and correction component to retrieve the capabilities of each component and stores the information.
2. The Administration Component to request a list of all Data Input Devices and the capabilities of the Meaning Extraction Component from the Dispatcher Component.
3. The Administration Component then assigns the capabilities of the Meaning Extraction Component to each Data Input Device via the Dispatcher Component.
4. Once the user request the Administration Component to start a session, the Administration Component is assigned a unique session ID. The Administration Component then signals the Raw Data Component to start recording.
5. Once the Raw Data Component has captured a packet of data, metadata information is attached and both are then sent to the Dispatcher Component.
6. The Dispatcher Component sends this information to the Meaning Extraction Component.
7. The Meaning Extraction Component analyses the data and append the analysed data to the metadata.
8. The metadata is then sent back to the Administration Component via the Dispatcher Component to be displayed for the user. The metadata and data are also stored within the Meaning Extractor Component.
9. Steps 5 to 8 continue until the Administration Component request that data recording be stopped. The Raw Data Component is informed of this via the Dispatcher Component.

### Session Analysis Process

1. Once the recording has stopped, the Administration Component can request a full analysis of the session. The request is sent to the Meaning Extractor Component via the Dispatcher Component.
2. The Meaning Extractor Component performs the analysis using the information stored in its archive. Once the analysis is complete, the results are sent to the Administration Component via the Dispatcher Component. The type of analysis performed is dependent on the capabilities of the Meaning Extractor Component.
3. The Administration Component then displays this information.

### Correction Process

1. The analysed results can then be sent to the Correction Component via the Dispatcher Component if requested by the Administration Component. This can be done either manually by the user selecting the analysed results to be corrected or the Administration Component can automatically use the metadata to decide whether correction is required.
2. Human and/or machine will then analyse the results and correct it if necessary.
3. The corrected results are then sent to the Dispatcher Component. The Dispatcher Component then sends the corrected results to the Administration Component to be displayed to the user and the Meaning Extractor Component such that it can learn from its mistakes.

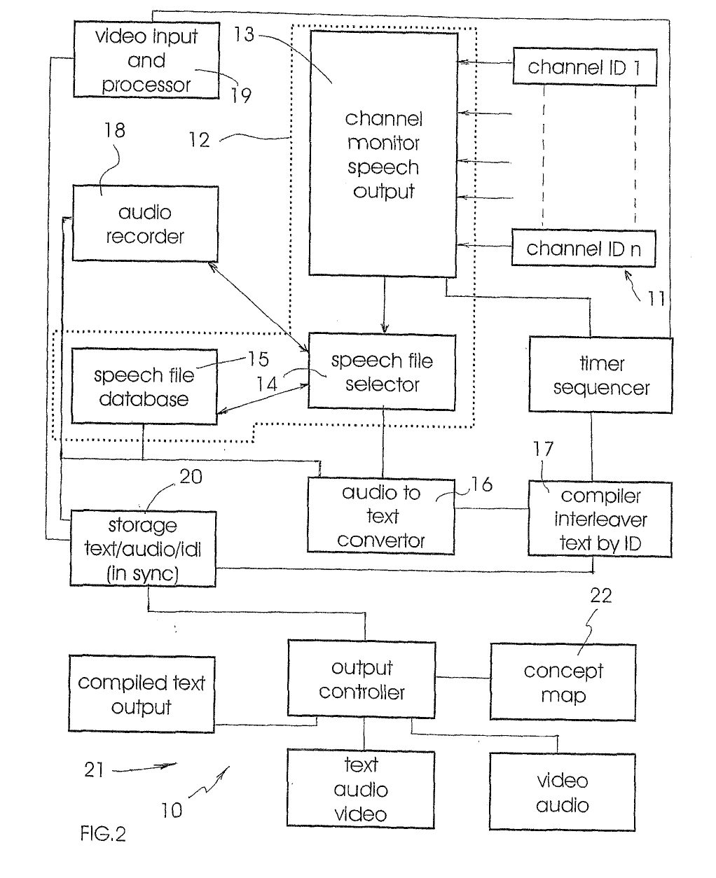

Referring to the other drawings and initially to FIG. 2, there is illustrated a system 10 for producing a transcript of a meeting comprising n attendees, the attendees being identified as ID1 to IDn and channel 1 to channel n respectively at 11. A speech discriminator is shown by that section of the system set out in the broken outline at 12 and comprises a channel monitor which generates a speech output from one or more, sequentially analysed channels 1 to n at any one time, a speech file selector at 14 and a speech file database at 15. Discrimination in the present embodiment is on the basis of pre-allocated channels which correspond to pre-allocated microphones and these are matched by ID and to the speech files in the speech file database. The effect of 13, 14 and 15 is to match a channel input to a particular speech file in the database 15 so that this information may then be passed to the audio to text convertor such that the speech file information and the input audio may be converted to text, displayed and written to a text file.

In the illustrated embodiment the individual audio files are recorded separately for each channel and the audio to text conversion is performed separately for each channel. The audio to text convertor typically utilises the known technology of a proprietary speech recognition software and its output is in the form of text produced in near real time and delivered to the compiler interleaver. The compiler interleaver in conjunction with a timer or sequencer process compiles the text from the different audio inputs so that the text from the individual channels is displayed in the sequence in which it was delivered as the speech output from the channel monitor.

The text of the individual audio inputs and therefore the individual attendees is typically flagged by ID so that each section of text attributed to each attendee may be later processed on the basis of ID. Thus each text section has unique co-ordinates of ID and utterance time or sequence number.

The audio is recorded for future use at 18 and a video input may also be employed at 19 so that the meeting has video, audio and text record which may be stored at 20. The storage process may typically involve anytime adjustments for the delay in text processing so that ultimately an output of the compiled text, audio and video will be in sync. Synchronisation resolution may be at utterance level or at individual word level. This is illustrated generally in relation to the output controller at 21 but it will be appreciated that individual text, audio and video files may be recorded in standard format digital recordings for further processing.

It will be appreciated that the text, video and audio may be replayed separately but in the sense of the present invention the additional co-ordinate of time added to ID and sequence number gives rise to a combination where analysis of text may give rise to identifying potentially useful corresponding sections of video and audio that carry addition information. For example, assume a moot training meeting involves settlement negotiations in patent dispute. Analysis of the text for words such as “categorically”, “disagree” “reject” and “refuse” may identify stalemates or points of contention, these may then be further analysed by the video and audio of those sections. Likewise analysis of the text for words such as “agree”, “agreement”, “accept” and “concur” may identify points of agreement. These section of video may then be analysed as to other factors including body language and voice tone and intonation etc. Thus the combination arises through the potential interaction arising from the mode of analysis of the text audio and video at the same time as identified through the post meeting text analysis.

One preferred output and post text analysis to be described below is the is generation of a concept map illustrated generally at 22.

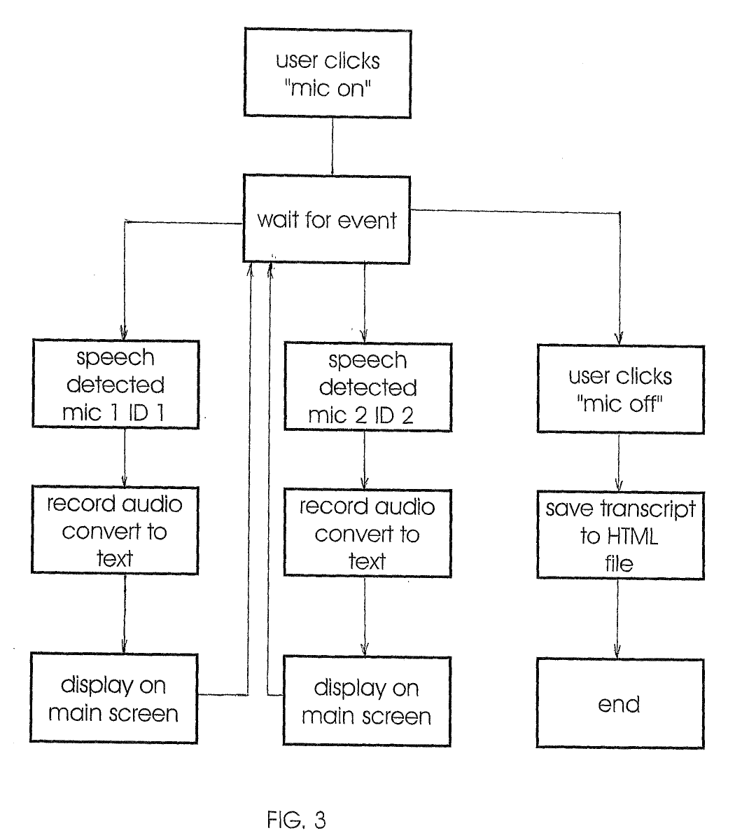

Referring now to FIG. 3, there is a flow chart illustrating schematically the broad elements of the process by which a meeting is initiated, recorded and saved. To commence the meeting, the user or users click a “mic on” button either to switch the microphones on collectively or to initiate individual microphones. In FIG. 3 embodiment, for clarity, the system is utilised in this case in relation to two microphones only but it will be appreciated that any number of microphones may be employed subject to processing capacity and hardware limitations that may be embodied in the computer system involved at the time. The other drawings refer to 1-n attendees.

The present invention utilises the sequence of speech to position text and accordingly speech from n channels may be recorded at any one time. Thus the events may be that speech is detected on microphone one for ID1 on channel 1 and this initiates the recording of the audio and conversion of that audio to text using the speech file allocated to channel 1 and simultaneous display of that text on a main screen and writing into a text file of a word processor. Should a reply to the initial speech be detected from attendee ID2 then the channel monitor will recognise the change in channel by a change in the input location, not by change in the speaker. Since that input channel has been allocated to attendee ID2, the speech recognition software will switch user to profile for ID2 and this will be utilised in relation to the speech output from the second monitor and be processed such that the audio is recorded and converted to text using the speech file allocated to ID2 or channel 2 and this is displayed on the main screen after the display of the previous speaker and this process continues until the meeting ends.

The effect of this sequential display is to compile the text in near to real time and as long as the microphones are on, the text will be displayed according to the microphone allocated to the particular channel and the speech file allocated to that channel until one of the users clicks “microphone off” button. Progress saving may a occur with the completion of every utterance ultimately this will result in saving of what has been displayed to a file as well as saving of the input audio to a series of audio files. Clearly, this then completes the end of the meeting.

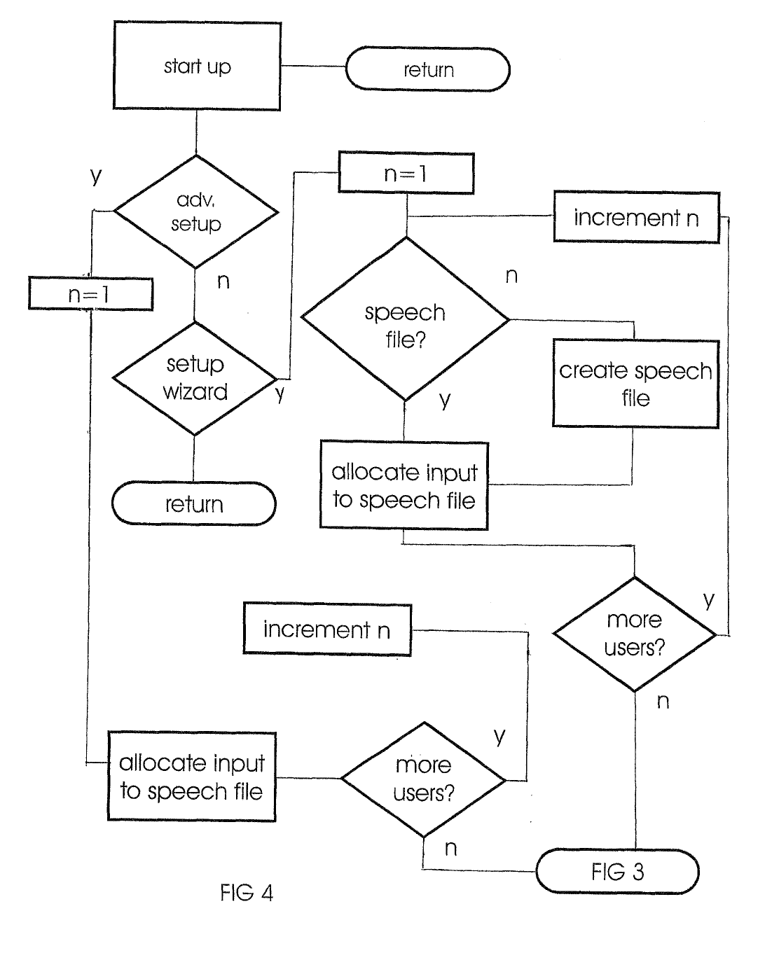

It will, of course, be appreciated that once speech files have been created for individual users then these can be saved in the speech file data base for future use. In addition, if proprietary speech recognition software is being employed, then those attendees to use that software on a regular basis in non-meeting situations may simply provide a copy of a speech file so that it may be inserted into the database to use at a meeting. In some cases, of course, people will attend the meeting and they will not have a speech file at all. FIG. 4 illustrates the process by which speech files are allocated 1 to n microphones for up to n attendees. Illustrated in the embodiment of FIG. 4 there is the option to utilise an advanced set up process for n users where existing speech files exist and it is simply a matter of allocating microphones and their corresponding channels to each user's speech file and once the full number of allocations has been made the sequence reverts to the sequence of FIG. 3.

In the illustrated embodiment a wizard set up process is also illustrated.

It will be appreciated that once a text transcript is available and this text transcript is able to produce a digital record of the contributions of each individual via the channel input and the microphone allocation that text file, audio file or video file and the combination thereof may be analysed to identify a whole host of characteristics of the individuals at the meeting and their relationship to others, their contributions to the meeting and so on.

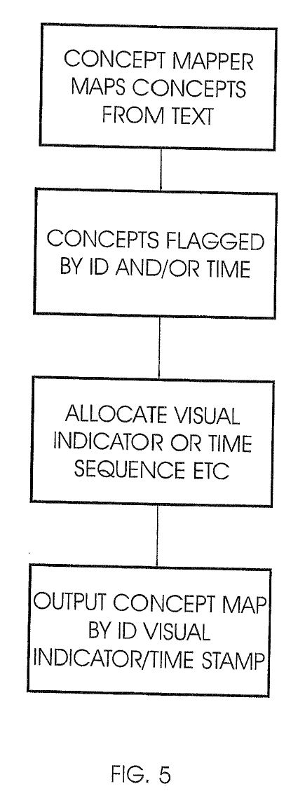

A team contribution of individuals may be identified, the prominence, assertiveness or other factors that may have an adverse or advantageous effect upon the meeting process and outcome may be identified by utilising an automated analysis of the meeting and generation of a report. In this analysis, the utterance times created by the sequencer and inserted into the document, held both as text and meta-data are of critical importance. One example in the present illustration is the use of a concept map and FIG. 5 illustrates how the text from the meeting may be utilised to provide a concept map using proprietary concept mapping software. While this is useful in a general sense, further information may be obtained from the concept map by utilising the capability of identifying individual contributions to the concept map in accordance with the IDs provided for that section of text from which the concept has been retrieved.

This enables the output of a concept map highlighted by ID and may flag dominant contributors or other factors which may enable team leaders to counsel individuals as to their contribution and so on. Furthermore, it also allows statistical rather than intuitive analysis of concept/idea generation as a function of meeting length, the plotting of idea introduction against length of group membership, and the shift in ideas and attitudes over time of individuals or groups.

The present invention by utilising identification in relation to output enables systematic reporting and identification of individual contributions in relation to the particular meeting on an automated basis.

Whilst the above has been given by way of illustrative example of the present invention many variations and modifications thereto will be apparent to those skilled in the art without departing from the broad ambit and scope of the invention as herein set forth in the following claims. For example, reports may be generated in relation to the meeting sequence including, but not limited to, the concept map example given in the present application. Other forms of analysis may arise through related timing of video events, important extracts from the meeting in terms of video, audio and text may generate combined video, audio and text reports and thereby improve the efficiency of the meeting process and the team building capacity of a group in real world and education environs.

1. A system for producing a transcript of a meeting comprising n attendees, the system comprising at least one audio input device to receive individual utterances from attendees, a voice discriminator to discriminate between individual attendees' utterances, an audio to text convertor to convert the utterances to text and a compiler to compile the converted text into a meeting transcript.

2. A system according to claim 1 wherein the system involves analysis of the text as a management tool by including automated post text analysis using attendee identifiers (ID) and relating that to specified characteristic of the text.

3. A system according to claim 1 wherein the system is used to identify management parameters selected from the following:
frequency of contribution,
concepts contributed, or
assertiveness.

4. A system according to claim 1 wherein the system where the transcript is combined with video of the meeting and/or audio so that sections of extracted text identified as assertive or abusive may be further analysed to assess body language and other factors that might lead to improved meeting style or identify strength and weaknesses of attendees.

5. A system according to claim 1 wherein the system comprises a management tool comprising a speech to text system to provide a transcript of a meeting involving attendees, each attendee having unique identifier, the tool including post meeting text analysis so that each attendees contribution may be extracted for further analysis or is analysed against certain predetermined criteria.

6. A system according to claim 1 wherein the system comprises a management tool comprising a speech to text system to provide a transcript of a meeting involving attendees, each attendee having unique identifier, the tool including post meeting text analysis so that each attendees contribution may be extracted for further analysis or is analysed against certain predetermined criteria indicative of an individuals capacity to function as a member of a team.

7. A system according to claim 1 wherein the voice discriminator comprises pre-allocation of microphones to attendees so that the microphones and associated input channels correspond to pre-stored speech profiles for the respective attendees.

8. A system according to claim 1 wherein individual attendee's utterances are processed separately using respective channels and a timer sequence is used in conjunction with the compiler to create the transcript from the individual text.

9. A system according to claim 1 wherein individual utterances are time stamped.

10. A system according to claim 1 wherein the compiler interleaver utilises flags of individual input to the meeting by time or by sequence.

11. A system according to claim 1 wherein the compiler interleaver utilises flags of individual input to the meeting by sequence where a number is allocated to each utterance and the number incremented and the compilation is generated by reproducing the text of each channel in numerical sequence.

12. A system according to claim 1 wherein the output involves video and/or audio output in sequence with text there being a timer delay created by text conversion process is imposed on the video and audio.

13. A system according to claim 1 wherein the compiler interleaver utilises flags of individual input to the meeting by time.

14. A system according to claim 1 wherein utterances are flagged by attendee ID for the generation of concept maps, and concept maps are generated concept maps which identify the contributions of individual attendees.

15. A system according to claim 1 for producing concept maps of a meeting comprising n attendees, the system comprising a voice discriminator to discriminate between individual attendees' utterances, an audio to text convertor to convert the utterances to text and a concept mapper to extract key concepts from the text and present those in a graphical form.

16. A system according to claim 1 for producing concept maps of a meeting comprising n attendees, the system comprising a voice discriminator to discriminate between individual attendees' utterances, an audio to text convertor to convert the utterances to text and a concept mapper to extract key concepts from the text and present those in a graphical form identifying the concepts of attendees using attendee identifiers and time/sequence tags to track development of ideas/concepts over time.

17. A system according to claim 1 wherein the system uses a vocabulary that is not general use for voice recognition but is tailored to the technical vocabulary of the individual making the utterances.

18. A process for temporal tracing of cognition development including development of a relationship between ideas/concepts over time, time tracking the way in which links between concepts and ideas become evident to members of a group, allowing the strength of an idea/concept pair to be tracked over time, both on an individual basis and through the group as a whole.

19. The process according to claim 18 which comprises using a system for producing a transcript of a meeting comprising n attendees, the system comprising at least one audio input device to receive individual utterances from attendees, a voice discriminator to discriminate between individual attendees' utterances, an audio to text convertor to convert the utterances to text and a compiler to compile the converted text into a meeting transcript.
